(19) United States
(12) Patent Application Publication
(10) Pub. No.: US 2006/0120397 A1
(43) Pub. Date: Jun. 8, 2006

(54) Wireless network based radio communication system

(76) Inventors: Barrett Kreiner, Norcross, GA (US); Jonathan Reeves, Roswell, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/007,030

(22) Filed: Dec. 6, 2004

(51) Int. Cl. H04J 3/16

(52) U.S. Cl. 370/437

(57) ABSTRACT

A system for providing radio communications is provided that includes a wireless network having at least two repeater/transceivers for dynamic channel allocation. Radios communicate with the repeater/transceivers. The system provides secure communication among radios, communication from one radio to a group of radios, and relayed communication from one radio to another. Each radio has a processor for compressing, encrypting, and storing communication data.

### BACKGROUND OF THE INVENTION

1. Field of the Invention

The present disclosure relates generally to wireless cellular, wireless fixed, and Internet communication systems, security, network management and, in particular, to radio communications.

2. Description of Related Art

Consumer wireless technology is not suitable for emergency communications or public service events, because communications are limited by available frequencies that are allocated by the Federal Communications Commission (FCC) and shared by many users.

Some communication systems have a common channel. A group of radios can tune to a particular frequency, the common channel. When a user keys up or opens a radio to transmit on the common channel, all other users tuned to the common channel hear the user's speech. If another user tries to key up while the first user is talking, there is an overlap and information becomes garbled or the speech is not sent.

Some communication systems have tried to avoid these over-talking problems with trunking. Trunking allows multiple agencies or departments to communicate using a common set of frequencies. A trunking system allocates certain frequencies to each user and each user's radio must be able to handle all of the frequencies. A central trunking infrastructure instructs each user to talk on a particular frequency at a particular time so that no user collides with any other user, preventing overlaps. The trunking infrastructure prevents a second user from keying up to the same channel that a first user is using, until that channel is clear. Trunking has a fixed number of frequencies, which can be saturated if all the users try to talk at once, because all the frequencies are allocated.

Some communication systems use group codes to allow different agencies and groups to utilize the same set of frequencies in groups so that they don't talk over each other. Suppose, a fire service, police service, and a community service all using the same frequency with trunking radios. When a user in the fire service keys up, there is a leader code sent to the infrastructure. The infrastructure activates only the radios that are keyed to that leader code. There are also fleet codes and subcodes. Sometimes a group can be shut out of communication if their codes are not synchronized with another group's codes. This can be a disastrous and potentially lethal situation. There is a need to prevent this from happening. Group codes require a frequency to be used by only one user at one time. Frequencies are scarce and expensive. There is a need to utilize frequencies by more than one person at a time in a communication system that is shared between different emergency and community services groups.

In a variety of situations, there will be service person in a number of jurisdictions trying to communicate. They may not all use the same set of frequencies or types of radios. In order to facilitate communication, often radios are traded. For example, a fire service radio may be traded with a police radio so that one radio in the fire department can communicate with the police department and one radio in the police department can communicate with the fire department. Then, there is a relay person who listens to information over one radio (e.g., fire department radio) and repeats the information over another radio (e.g., police department radio). Alternatively, emergency or community service personnel use telephones or cell phones to repeat radio communications. Relayed information is sometimes not as accurate as the original information and it takes time to relay the information.

There is a need for a wireless network based emergency communication system that is tolerant to interference, avoids delays, utilizes more bandwidth, and is more likely to be available in an emergency.

### BRIEF SUMMARY OF THE INVENTION

Exemplary embodiments of the present invention include systems, methods, and storage devices for providing radio communication.

One exemplary embodiment is a system for providing radio communications, including a wireless network, repeater/transceivers, and radios. The wireless network handles voice and data digital signals. The repeater/transceivers communicate with the network for dynamic channel allocation. The radios communicate with the repeater/transceivers for secure communication among the radios, communicate to a group of radios, and communication is relayed from one radio to another radio. Each radio has a processor for compressing, encrypting, and storing communication data.

Another exemplary embodiment is a handset for providing radio communications, including a receiver, a transmitter, and a processor. The receiver receives incoming digital signals, including voice and data over a network having dynamic channel allocation. The transmitter transmits outgoing digital signals including voice and data over the network. The processor compresses, encrypts, and stores communication data. Communication to/from other handsets, communication to/from groups of handsets, relayed communication to/from other handsets is transceived.

Another exemplary embodiment is a method for providing radio communications. Messages are encrypted, digitized, and compressed on a first handset, before being transmitted over a network to a second handset. The network connects multiple transmitters and performs dynamic channel allocation. Messages are prioritized on the first handset so that higher priority messages are transmitted before lower priority messages. The first handset sends a message to a group of handsets. The group is defined by the first handset.

Another exemplary embodiment is a storage medium storing instructions for performing a method for providing radio communications. Incoming digital signals are received on a handset from a network having dynamic channel allocation. The incoming digital signals include voice and data. Outgoing digital signals are transmitted from the handset over the network. Communication data is compressed, encrypted, and stored on the handset. Communication to/from other handsets, communication to/from groups of handsets, relayed communication to/from other handsets is transceived.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF SEVERAL VIEWS OF THE DRAWING

These and other features, aspects, and advantages of the present invention will become better understood with regard to the following description, appended claims, and accompanying drawings where:

FIG. 1 is a block diagram showing a network according to exemplary embodiments; and

FIG. 2 is a block diagram showing radios according to exemplary embodiments.

### DETAILED DESCRIPTION OF THE INVENTION

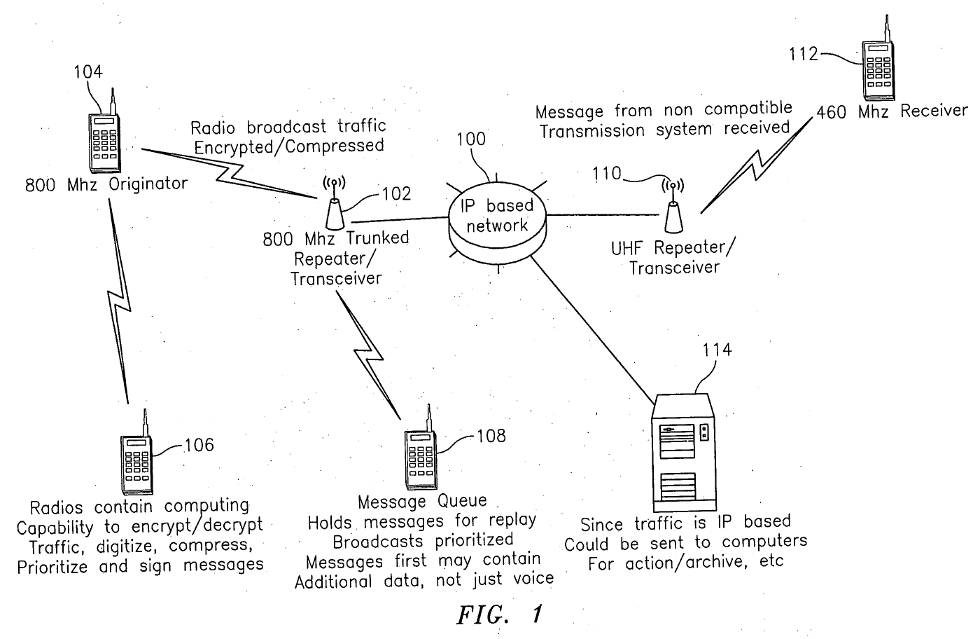

FIG. 1 shows a network according to exemplary embodiments. An Internet Protocol (IP) network 100 is in communication with a trunked repeater/transceiver 102, which is in communication with an originator 104, which is in communication with a number of other radios 106. The trunked repeater/transceiver 102 is in communication with a radio 108 having a message queue. The IP network 100 is in communication with another repeater/transceiver 110, which is in communication with a receiver 112. The IP network 100 is also in communication with a computer 114.

The IP network 100 is part of a modified trunked radio system. A trunked radio system is a system in which users share or pool a number of radio channels. Frequencies are distributed by the system according to demand and traffic levels. This exemplary embodiment includes compression, encryption, security, voice over IP technology, and other technologies to provide more communication over existing frequencies than traditional trunked radio systems.

The IP network 100 uses point-to-point, group codes, priority interrupts, and general broadcast, among other features. The IP network 100 includes infrastructure and handsets for a radio communication system that uses a packetized communication protocol, such as transmission control protocol (TCP)/IP.

The IP network 100 uses voice compression technology to reduce the bandwidth on channels. A voice grade telephone line has about 56 Kbs of data. Radio uses less bandwidth, but generally includes a certain amount of frequency to encode the voice onto the radio frequency using frequency modulation. The same amount of bandwidth on one channel, with compression technology and packetizing, can encode several concurrent communications on that channel. For example, a regular FM quality single channel communication can be carried in about 14 Kbps, so four voice grade communications of about 56 Kbs can be packed into that 14 Kbps bandwidth.

The trunked repeater/transceiver 102 has a frequency of 800 MHz, in this exemplary embodiment.

The originator 104 has a frequency of 800 MHz, in this exemplary embodiment.

The other radios 106 include computing capability to encrypt and decrypt traffic and to digitize, compress, prioritize, and sign messages.

In the IP network 100, groups of computers are identified for a multi-task or overriding broadcast event. The radio 108 has a message queue that hold messages for replay. The radio 108 broadcasts prioritized messages first. Messages may contain other data in addition to voice data.

The repeater/transceiver 110 is UHF band, which is capable of receiving messages from a receiver 112, which is from a system that is not compatible with the other radios 106.

The computer 114 may receive traffic for various actions and archiving. In some embodiments, computer 114 performs compression, encryption, security, access control, prioritization, storage and the like. In other embodiments, radios 104, 106, 108, 112 may perform a portion or all of these functions alone or in combination with computer 114. In some exemplary embodiments, in place of the computer 114, processors are placed in handsets and/or repeater/transceivers.

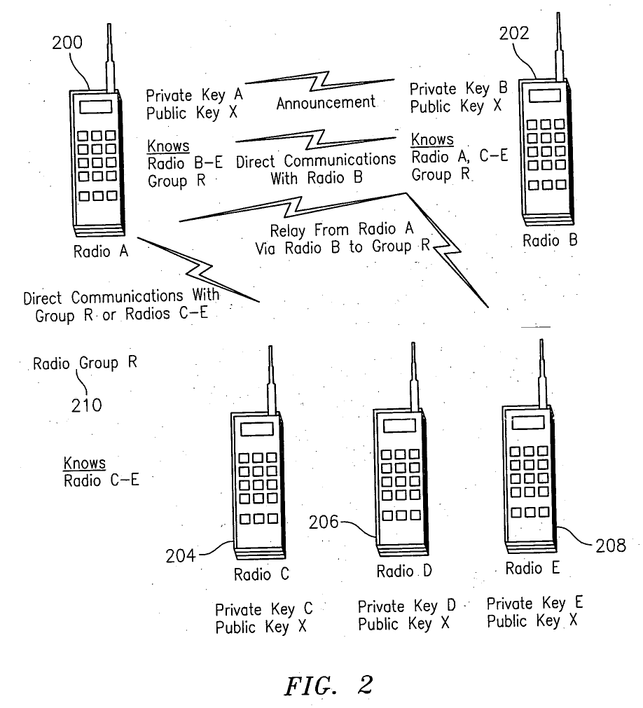

FIG. 2 shows radios according to exemplary embodiments. A radio A 200 communicates with radios B 202 C 204, D 206, and E 208. Radio group R 210 includes radios C 204, D 206, and E 208. The exemplary embodiment shown in FIG. 2 has secure communications using public key infrastructure (PKI). Each radio has a private key and a public key.

As shown in FIG. 2, various kinds of communications may occur, such as an announcement from radio A 200 to radio B 202, direct communication between radios A 200 and B 202, a relay from radio A 200 via radio B 202 to group R 210, direct communication between radio A 200 and radio group R 210, direct communication between radio A 200 and any of radios C, D, or E, and other communications.

FIG. 2 shows exemplary radio handsets; however, many kinds of handsets may be used. Handsets typically include a speaker, a receiver, an antenna, a push to talk button, and a power supply. Exemplary embodiments include electronic components for communication within IP network 100 in FIG. 1, such as components for encryption, compression, digitizing, and other the like. Exemplary embodiments may include computing devices inside handsets to perform compression, encryption, security, access control, prioritization, storage and the like. For example, a handset may store incoming voice data when the handset is transmitting and receiving at the same time. Hardware in the handsets may include priority or access rules, mechanisms for routing data to local storage for playback, interactions between speaker, microphone, radio, storage, and mechanisms for other displays or buttons that are part of the handsets.

An exemplary system is packet-based without repeater or network control, where radios transceive directly to/from each other. This exemplary system includes at least two handsets. Each handset includes a speaker, a microphone, integrated circuitry to support radio transmission, such as crystal and frequency modulation equipment, an antenna, a frequency modulator, and a processor to process audio input and output from radios, e.g., data compression, and to route data on a network.

The exemplary system may also include additional features, such as encryption and non-local communication, where one handset can directly hear another handset and repeaters hear radio signals and rebroadcast them in place of the other handsets, extending the range of the system. Also, if different handsets are working on different frequencies, then transceivers may be included to patch data on one frequency and retransmit it on another frequency. To extend range even further, multiple transmitters connected via a voice or data line may be included, extending to several towers to a very large area, up to including the entire earth's surface. In some exemplary embodiments, packetized data on the network is transceived to/from another network. Some exemplary embodiments include voice over IP (VOIP) to include a landline communication (telephone call) from a handset to someone who is not on the network, or to a cellular phone, or to another traditional radio system, and the like. A patch may be done at a repeater tower or anywhere that the data packet can touch the network. This is advantageous because the patch can carry additional data and that patch can happen anywhere one can touch the network, whereas in conventional systems, equipment must be nearby, almost physically touching each other.

In addition to carrying voice, an exemplary system also carries out-of-band data. A sub-audible frequency carried on a voice channel opens and closes the microphone, and carries out-of-band data along with the voice traffic which may provide information used in a display on the handset, like caller ID, handset ID, including specific information, such as alert activations, time and date stamp, GPS locations, and other kinds of data on the network. Data may be acquired either at the handset or upstream.

One exemplary embodiment includes stored voice data that is available for replay and pipelined so that when a user is talking, the user's voice is keyed up and priority transmissions jump ahead of any stored messages. Messages are marked by the handset as urgent and are sent ahead of other traffic. For example, the message “Evacuate the building now.” would be a priority message that would be moved more quickly to the destination than other messages. Any indications, such as a red button or vibration at the destination may also be used to indicate priority information or provide a selection of a priority message over other messages.

In one exemplary embodiment, security provides privacy and encryption of data and identification of handset users so that a compromised device may be shutoff.

One exemplary embodiment includes group features. It has an infrastructure that defines group codes and allows users to build a list of users in a group on a handset. An identifier that is included in transmitted data identifies group members. The identifier associates the data with that member's handset.

One exemplary embodiment has the ability to transparently switch from peer-to-peer to repeater mode. Radios that are listening form peers in the area. If peers are in the area, they address other peers (handsets) directly; otherwise, peers address the repeater to send packets. This reduces the amount of traffic through the repeaters, freeing up bandwidth, reducing the time of transmission, reducing latency, and reducing power.

One exemplary embodiment includes messaging features. An operator arbitrates group codes, and the priorities among groups according to defined rules. A handset may belong to any number of groups. At least one repeater includes storage so that if a handset misses particular packets or a whole message, the repeater retransmits those packets or messages, increasing the quality of communication.

One exemplary embodiment has a stored voice feature. When signaled, a radio records voice for a period of time that can be played back. This feature is a built into the radio. Another feature includes the case when a dispatch radio sends information. If any receiving radio missed some of the information, it may request that the repeater resend the missed information or request additional information.

One exemplary embodiment includes a cloning process. The cloning process propagates a particular configuration of a handset throughout a number of handsets. The configuration includes settings of handsets, assigning frequencies and the like. In the cloning process, individual public/private keys are not cloned; instead, group keys are cloned. Also, if a given unit is compromised, its public key can be removed from the system (i.e., put on a blacklist). During cloning and configuration, units preferably have the ability to generate a new public/private key pair.

An exemplary embodiment includes a handset that has traditional radio equipment, power, receiver, transmitter, antenna, integrated circuits, and the like and also has a processor. This system uses PKI to assign a credential to each radio. The credential is a private key used for encryption of outgoing traffic, a public key and identifier to allow other devices to decrypt information. Each unit that is encrypting or signing a message has a unique public and private key. For groups, the group itself has a public and private key that each unit participating in the group uses. The system stores public keys for other devices. For every group channel, the device will have a key for the group. This information is provided as part of a cloning process.

When the device in this exemplary embodiment is turned on, the device announces itself and listens for peers or other friendly devices, such as handsets, base stations, gateways, and repeaters. The relative strength of each signal is recorded. This map changes over time. The device also listens for relay marked messages, indicating that a device is unable to talk directly to another device. If the source and destination devices, or repeaters thereof, are within range, the device announces itself as a repeater for that route in a manner similar to IP routing tables. When the user speaks into the radio, the speech is converted to digital signals, packetized, compressed, encrypted, and transmitted to the destination device. The power used to transmit the signals is adjusted based on the relative strengths of the signals. The destination device sends an acknowledgement to the sending device, confirming receipt of the message. Concurrent conversations take place on a given frequency. As the frequency increases, the opportunity to allocate a wider amount of bandwidth increases (as the FCC allocates more bandwidth per frequency in the higher frequencies), but the range of the broadcast decreases. The radio listens not only for directed messages, but group messages as well.

The exemplary embodiment optionally includes many features. A handset with a processor performs encryption, learns and stores information about other groups and devices for access and security, stores the relative strengths of each signal, listens for relay marked messages and acts as a repeater to pass messages when peer-to-peer communication is unavailable, converts speech to digital signals. The processor packetizes, compresses, encrypts, and transmits messages to destination devices, and has variable power. Multiple concurrent conversations take place on a frequency. The radio listens for group messages signed with a group credential, similar to a wireless fidelity (WiFi) service set identifier (SSID). Radios are keyed to monitor multiple channels. Devices use local storage to prioritize messages. Devices may have a repeat button.

As described above, the embodiments of the invention may be embodied in the form of hardware, software, firmware, or any processes and/or apparatuses for practicing the embodiments. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. For example, exemplary embodiments have many applications, including any radio communications, telecommunications, emergency communications, homeland security, military applications, commercial construction crews, dispatching taxis, and other varied applications. Exemplary embodiments are not limited to trunking radio systems. Exemplary embodiments may be used for any frequency or bandwidth. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A system for providing radio communications, comprising:
a wireless network for voice and data digital signals;
at least two repeater/transceivers in communication with the network for dynamic channel allocation;
a plurality of radios in communication with the repeater/transceivers for secure communication among the radios, communication to a portion of the radios belonging to a group, and for relaying communication from one of the radios to another radio, each radio having a processor for compressing, encrypting, and storing communication data.

2. The system of claim 1, wherein several concurrent communications are encoded on a single channel.

3. The system of claim 1, wherein the repeater/transceivers retransmit stored communication to one of the radios, upon request.

4. The system of claim 1, wherein one of the radios is not able to communicate directly with the other radios and is able to communicate indirectly with the other radios through one of the repeater/transceivers.

5. The system of claim 1, wherein the radios are trunking radios.

6. A handset for providing radio communications, comprising:
a receiver for receiving incoming digital signals including voice and data over a network having dynamic channel allocation;
a transmitter for transmitting outgoing digital signals including voice and data over the network;
a processor for compressing, encrypting, and storing communication data;
wherein communication to/from other handsets, communication to/from groups of handsets, relayed communication to/from other handsets is transceived.

7. The handset of claim 6, wherein the processor digitizes voice and data.

8. The handset of claim 6, wherein the processor applies security and prioritization rules to communication data.

9. The handset of claim 6, further comprising:
a storage device for holding messages in a queue for replay, the storage being accessible by the processor.

10. A method for providing radio communications, comprising:
encrypting, digitizing, and compressing messages on a first handset before the messages are transmitted over a network to a second handset, the network connecting multiple transmitters and performing dynamic channel allocation;
prioritizing messages on the first handset so that higher priority messages are transmitted before lower priority messages; and
sending a message from the first handset to a group of handsets, the group being defined by the first handset.

11. The method of claim 10, further comprising:
re-broadcasting a message stored on a first handset to the second handset.

12. The method of claim 10, further comprising:
transmitting communication from the network to second network, the second handset being in communication with the second network.

13. The method of claim 1 1, wherein the second network performs voice over Internet Protocol (VOIP), landline communication, or cellular communication.

14. The method of claim 11, further comprising:
patching data on one frequency and retransmitting it on another frequency.

15. A storage medium storing instructions for performing a method for providing radio communications, the method comprising:
receiving incoming digital signals on a handset from a network having dynamic channel allocation, the incoming digital signals including voice and data;
transmitting outgoing digital signals from the handset over the network;
compressing, encrypting, and storing communication data on the handset;
wherein communication to/from other handsets, communication to/from groups of handsets, relayed communication to/from other handsets is transceived.
